(19) United States
(12) Patent Application Publication
(10) Pub. No.: US 2015/0088657 A1
(43) Pub. Date: Mar. 26, 2015

(54) ADVERTISEMENT DELIVERY APPARATUS AND ADVERTISEMENT DELIVERY METHOD

(71) Applicant: YAHOO JAPAN CORPORATION, Tokyo (JP)

(72) Inventor: Hiroshi OTA, Tokyo (JP)

(21) Appl. No.: 14/329,198

(22) Filed: Jul. 11, 2014

(30) Foreign Application Priority Data
Sep. 20, 2013 (JP) 2013-195865

(51) Int. Cl. G06Q 30/02

(52) U.S. Cl. CPC G06Q 30/0267
USPC 705/14.64

(57) ABSTRACT

An advertisement delivery apparatus according to an embodiment includes a first advertising information output unit and a second advertising information output unit. The first advertising information output unit outputs advertising information according to user information on a company corresponding to an entry site of a wireless terminal as first advertising information to the wireless terminal. The second advertising information output unit outputs advertising information according to a user having a wireless terminal when the wireless terminal accesses a server as second advertising information to the wireless terminal. One of the first and second advertising information output units outputting, to the wireless terminal to which the advertising information of the other advertising information output unit is output, advertising information related to the advertising information output from the other advertising information output unit.

### CROSS-REFERENCE TO RELATED APPLICATIONS

The present application claims priority to and incorporates by reference the entire contents of Japanese Patent Application No. 2013-195865 filed in Japan on Sep. 20, 2013.

### BACKGROUND OF THE INVENTION

1. Field of the Invention

The present invention relates to an advertisement delivery apparatus and an advertisement delivery method.

2. Description of the Related Art

The recent remarkable spread of networks such as the Internet has led to active network-based deliveries of advertisements. As one mode of such deliveries of advertisements, targeted advertising is known whereby advertisements are delivered to specific users having user information that matches specific delivery conditions (e.g., attributes, interest, etc., of users) specified by an advertiser (see, for example, Japanese Patent Application Laid-open No. 2009-223423).

The known advertisement delivery techniques are, however, concerned with delivery of advertisements based on user information an advertisement delivery service provider has and the delivery often fails to represent the intention of the advertiser.

### SUMMARY OF THE INVENTION

An advertisement delivery apparatus according to an embodiment includes a company information database, an entry information acquiring unit, a first advertising information output unit, and a second advertising information output unit. The company information database stores therein user information on a company. The entry information acquiring unit acquires entry information including information on a wireless terminal when the wireless terminal enters a site corresponding to the company. The information extracting unit extracts, from the company information database, the user information on the company corresponding to an entry site of the wireless terminal based on the entry information. The first advertising information output unit outputs advertising information according to the user information extracted by the information extracting unit as first advertising information to the wireless terminal. The second advertising information output unit outputs advertising information according to a user having a wireless terminal when the wireless terminal accesses a server as second advertising information to the wireless terminal. One of the first and second advertising information output units outputs, to the wireless terminal to which the advertising information of the other advertising information output unit is output, advertising information related to the advertising information output from the other advertising information output unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIGS. 1A and 1B are explanatory drawings illustrating an advertisement delivery process according to an embodiment of the present invention;

FIG. 2 is a diagram illustrating an exemplary specific configuration of an advertisement delivery system according to the embodiment;

FIG. 3 is a diagram illustrating an exemplary configuration of a wireless apparatus according to the embodiment;

FIGS. 4A and 4B are sequence diagrams for establishing a session between the wireless apparatus and a wireless terminal;

FIG. 5 is a diagram illustrating an exemplary configuration of an advertisement delivery apparatus according to the embodiment;

FIG. 6 is a diagram illustrating an exemplary partner company's user information table;

FIG. 7 is a diagram illustrating an exemplary terminal detection table;

FIG. 8 is a diagram illustrating an exemplary advertisement delivery history table;

FIG. 9 is a diagram illustrating an exemplary partner company information table;

FIG. 10 is a diagram illustrating an exemplary correspondence information table;

FIG. 11 is a diagram illustrating an exemplary advertising information table;

FIG. 12 is a diagram illustrating an exemplary user information table;

FIG. 13 is a flowchart illustrating information processing performed by the wireless apparatus according to the embodiment;

FIG. 14 is a flowchart illustrating information processing performed by an advertisement delivery apparatus according to the embodiment;

FIG. 15 is a flowchart illustrating information processing performed in an advertising information output process A illustrated in FIG. 14;

FIG. 16 is a flowchart illustrating information processing performed in an advertising information output process B illustrated in FIG. 14; and

FIG. 17 is a hardware configuration diagram of an exemplary computer that achieves functions of the advertisement delivery apparatus.

### DETAILED DESCRIPTION OF THE PREFERRED EMBODIMENTS

An advertisement delivery apparatus, an advertisement delivery method, and an advertisement delivery program according to an embodiment of the present invention will be described in detail below with reference to the accompanying drawings. It is to be understood that the embodiment does not intend to limit the advertisement delivery apparatus, the advertisement delivery method, and the advertisement delivery program according to the present application. In the following, “database” will be abbreviated to “DB”.

### 1. Advertisement Delivery Process

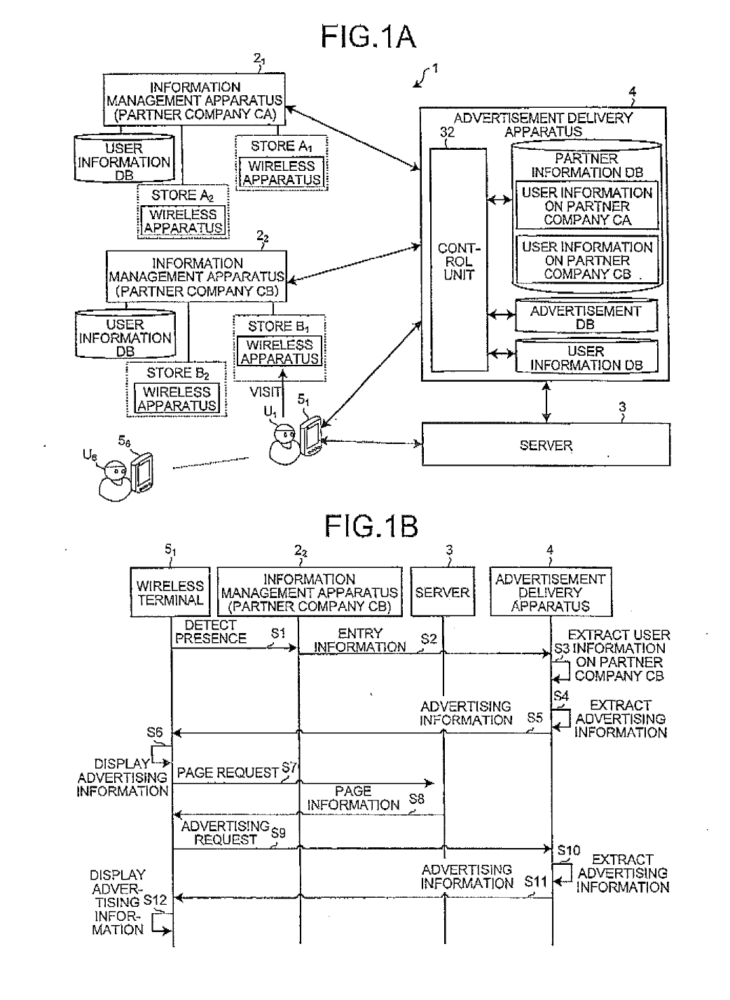

An advertisement delivery process according to the embodiment will first be described below. FIGS. 1A and 1B are explanatory drawings illustrating the advertisement delivery process according to the embodiment of the present invention. In the embodiment, the advertisement delivery process is performed by an advertisement delivery system.

1.1 Advertisement Delivery System

As illustrated in FIG. 1A, this advertisement delivery system 1 includes information management apparatuses 2₁, 2₂, a server 3, and an advertisement delivery apparatus 4. The information management apparatuses 2₁, 2₂ (hereinafter also collectively referred to as an information management apparatus 2) are managed and operated by partner companies CA, CB (hereinafter also collectively referred to as a partner company C), respectively. The advertisement delivery apparatus 4 is managed and operated by an advertisement delivery service provider.

The partner company C is a company that has made a partnership agreement with the advertisement delivery service provider. The partner company C may, for example, be a distributor having a store that provides commodities or service. The partner company CA is a company that provides commodities or service at stores A₁, A₂. The partner company CB is a company that provides commodities or service at stores B₁, B₂.

The partner company C may, for example, be, instead of the distributor, a performance show operator for concerts and sports events or a business operating a commercial space such as a hotel, a beauty parlor, a hospital, a movie theater, and a combined leisure facility.

The advertisement delivery system 1 provides wireless terminals 5₁ to 5₆ advertising information. The wireless terminals 5₁ to 5₆ are held by users U₁ to U₆ who visit a business place (hereinafter, “store”) such as a store or a facility of the partner company C or purchase a commodity or service at a store of the partner company C. In the following, the wireless terminals 5₁ to 5₆ may be collectively referred to as a wireless terminal 5 and the users U₁ to U₆ may be collectively referred to as a user U.

The wireless terminal 5 may, for example, be a smartphone, a mobile personal computer (PC), or any other portable wireless terminal. The wireless terminal 5 can communicate with the server 3 and the advertisement delivery apparatus 4 connected to a communication network (e.g., the Internet) over a wireless local area network (LAN) or portable telephone communication.

The information management apparatus 2₁ has a user information DB that stores therein user information owned by the partner company CA. The information management apparatus 2₂ has a user information DB that stores therein user information owned by the partner company CB. The advertisement delivery apparatus 4 acquires the user information owned by the partner companies CA, CB from the information management apparatuses 2₁, 2₂ and stores the acquired user information in a partner information DB (an exemplary company information DB).

Types of the user information stored in the user information DB include information on histories of visits and purchases made by the user U at a store of the partner company C (hereinafter also referred to as behavior history information) and identification information on the wireless terminal 5 (hereinafter, terminal ID). The behavior history information includes, for example, identification information for stores of the partner company C (hereinafter, store ID).

Each of the stores of the partner company C has at least one wireless LAN communication apparatus (hereinafter, wireless apparatus) installed therein. The wireless apparatus covers a wireless communication area within the store. The wireless apparatus detects a wireless signal of the wireless terminal 5 of the user U (hereinafter also referred to as entry user U) who enters the store of the partner company C, thereby detecting an entry of the wireless terminal 5 in the store. The information management apparatus 2 transmits to the advertisement delivery apparatus 4 entry information that includes information on the wireless terminal 5 detected by the wireless apparatus as a result of its entry in the store.

The wireless communication area of the wireless apparatus may include an area around the store, in addition to an area inside the store. This allows the wireless apparatus to detect not only the wireless terminal 5 of a user U who has entered the store, but also the wireless terminal 5 of a user U present in the area around the store.

A control unit 32 of the advertisement delivery apparatus 4, having received the entry information from the information management apparatus 2, extracts, from the partner information DB, user information on the partner company C corresponding to an entry site of the user U and supplies the wireless terminal 5 of the “in-store” user U with advertising information corresponding to the extracted user information.

The control unit 32 of the advertisement delivery apparatus 4 extracts, from the user information DB, information on the user U having the wireless terminal 5 who has accessed the server 3 and supplies the wireless terminal 5 of the “in-store” user U with advertising information according to the extracted user information.

In this manner, the advertisement delivery apparatus 4 can supply the wireless terminal 5 that has entered the site corresponding to the partner company C and the wireless terminal 5 that has accessed the server 3 with the advertising information according to the user information. The server 3 is, for example, a web server.

Additionally, the advertisement delivery apparatus 4 stores a delivery history of the advertising information supplied to the wireless terminal 5 in an advertisement DB. When delivering advertising information to the wireless terminal 5, the control unit 32 of the advertisement delivery apparatus 4 can extract, from the advertisement DB, advertising information related to the advertising information provided in the past for the wireless terminal 5 based on the delivery history of the advertising information and provide the extracted advertising information for the wireless terminal 5. This allows an advertising effect by the advertising information to be efficiently improved.

1.2 Exemplary Advertisement Delivery Process

The following describes, with reference to FIG. 1B, an exemplary advertisement delivery process performed when the user U₁ of the wireless terminal 5₁ visits the store B₁ and thereafter accesses the server 3. The following description assumes that the server 3 is a web server.

When the user U₁ of the wireless terminal 5₁ visits the store B₁, the wireless apparatus installed in the store B₁ detects a wireless signal output from the wireless terminal 5₁. The wireless apparatus notifies the information management apparatus 2₂ of the terminal ID of the wireless terminal 5₁ from which the wireless signal is output. This causes the information management apparatus 2₂ to detect presence of the wireless terminal 5₁ in the store B₁ (Step S1).

The information management apparatus 2₂ transmits to the advertisement delivery apparatus 4 entry information that includes the terminal ID of the wireless terminal 5₁ acquired from the wireless apparatus, the store ID of the store B₁, and identification information on the partner company CB (hereinafter, business ID) (Step S2). The entry information may, instead, be transmitted directly from the wireless apparatus installed in the store B₁ to the advertisement delivery apparatus 4.

The control unit 32 of the advertisement delivery apparatus 4 extracts user information from the partner information DB based on the entry information transmitted from the information management apparatus 2₂ or the wireless apparatus (Step S3). For example, the control unit 32 extracts, from the partner information DB, out of the user information on the partner company CB associated with the business ID included in the entry information, user information on the user U₁ associated with the terminal ID included in the entry information.

Alternatively, the control unit 32 may extract, as the user information extracted from the partner information DB, the user information on the user U₁ from the user information corresponding to the store B₁ of the partner company CB based on the business ID and the store ID.

The control unit 32 extracts, from an advertisement DB, advertising information corresponding to the user information extracted from the partner information DB (Step S4), and transmits the extracted advertising information (an exemplary first advertising information) to the wireless terminal 5₁ of the entry user U₁ (Step S5). The control unit 32 transmits the advertising information to the wireless terminal 5₁ via the wireless apparatus installed in the store or a portable telephone communication network.

A control unit of the wireless terminal 5₁ displays the advertising information acquired from the advertisement delivery apparatus 4 on a display of the wireless terminal 5₁ (Step S6). In this manner, the advertisement delivery apparatus 4 can provide the wireless terminal 5₁ of the entry user U₁ with the advertising information related to the partner company CB.

For example, an advertiser submits advertising information with delivery conditions that specify the partner company CB and a user attribute (e.g., an interest of the user U) to thereby be able to deliver the advertising information to the wireless terminal 5 of the user U having the specified user information out of the users U who use the partner company C. The advertiser may further include specification of a store in the delivery conditions to thereby deliver the advertising information to the wireless terminal 5 of the user U having the user information corresponding to the specified store.

If, for example, a manufacturer that provides commodities displayed in a store of the partner company C submits advertising information as an advertiser to the advertisement delivery apparatus 4, the advertising information can be delivered specifically to the user U of the partner company C. This enables the purchase of commodities to be promoted more effectively and with higher accuracy. Furthermore, the user information on the partner company C includes, for example, a purchase history of the commodities provided by the manufacturer. Therefore, for example, advertising information can be delivered specifically to the user U who has a history of purchase of a commodity promoted by the advertising information. This enables the purchase of commodities to be promoted more effectively and with higher accuracy.

The user U₁of the wireless terminal 5₁ may, for example, leave the store B₁ and access the server 3 via the portable telephone communication network at another site to make a page request (Step S7). Then, the server 3 transmits to the wireless terminal 5₁ page information corresponding to the page request (Step S8). The page information is, for example, HyperText Markup Language (HTML).

An advertising space having the advertisement delivery apparatus 4 as an access destination is set in the page information transmitted from the server 3. The control unit of the wireless terminal 5₁ makes an advertising request to the advertisement delivery apparatus 4 (Step S9). The control unit 32 of the advertisement delivery apparatus 4, when receiving the advertising request from the wireless terminal 5₁, extracts, based on an advertisement delivery history relative to the user U₁ of the wireless terminal 5, stored in a delivery history DB, advertising information (exemplary second advertising information) related to the advertising information provided for the wireless terminal 5₁ at Step S5 (Step S10).

The control unit 32 of the advertisement delivery apparatus 4 delivers the extracted advertising information to the wireless terminal 5₁ (Step S11). The control unit of the wireless terminal 5₁ acquires the advertising information transmitted from the advertisement delivery apparatus 4 over the portable telephone communication network and displays the advertising information on a display of the wireless terminal 5₁ (Step S12).

In this manner, the advertisement delivery apparatus 4 can provide the wireless terminal 5 of the entry user U with the advertising information related to the company corresponding to the entry site, so that the purchase of commodities can be promoted effectively and with high accuracy. Moreover, for a user U having the wireless terminal 5 that has thereafter accessed the server 3 or the like, advertising information related to the advertising information delivered when the above-described user U entered the site corresponding to the company can be provided to thereby perform retargeted advertising. The advertising effect of the advertising information to be delivered can thus be enhanced.

In addition, the advertisement delivery apparatus 4 may also provide a user U having the wireless terminal 5 that has entered the site corresponding to the company with advertising information related to the advertising information delivered when the above-described user U accessed the server 3. Also in this case, retargeted advertising can be performed, so that the advertising effect of the advertising information to be delivered can be enhanced.

### 2. Details of Advertisement Delivery System 1

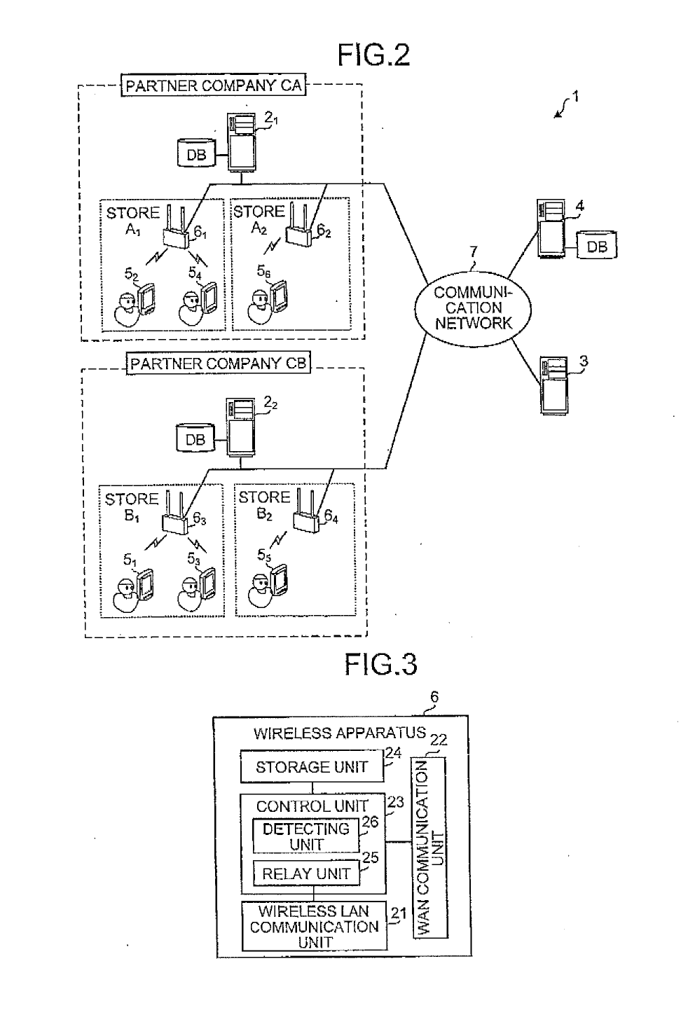

The following describes an exemplary configuration of the advertisement delivery system 1 according to the embodiment with reference to FIG. 2. FIG. 2 is a diagram illustrating an exemplary configuration of the advertisement delivery system 1 according to the embodiment.

As illustrated in FIG. 2, the advertisement delivery system 1 includes the information management apparatuses 2₂, 2₂, the server 3, the advertisement delivery apparatus 4, the wireless terminals 5₁ to 5₆, and wireless apparatuses 6₁ to 6₄ (hereinafter also collectively referred to as a wireless apparatus 6).

The information management apparatus 2, the server 3, the advertisement delivery apparatus 4, and the wireless apparatus 6 are connected to one another so as to be mutually communicable via a communication network 7. The communication network 7 is, for example, a wide area network (WAN) such as the Internet.

The example illustrated in FIG. 2 exemplarily includes the two partner companies CA, CB; however, the number of partner companies C may be one, or three or more. At least one wireless apparatus 6 is installed in each of the stores of the partner company C. In the example illustrated in FIG. 2, the wireless apparatuses 6₁, 6₂ are installed in the stores A₁, A₂, respectively, of the partner company CA and the wireless apparatuses 6₃, 6₄ are installed in the stores B₁, B₂, respectively, of the partner company CB.

The information management apparatus 2 has the user information DB that stores therein user information on the partner company C associated therewith. The user information stored in the user information DB includes, for example, the behavior history information for each terminal ID, updated by a control unit of the information management apparatus 2 for each visit or purchase by the user U. The control unit of the information management apparatus 2 transmits the updated user information to the advertisement delivery apparatus 4.

The server 3 is managed and operated by the advertisement delivery service provider. In response to access from the wireless terminal 5 over the communication network 7, the server 3 provides the wireless terminal 5 with, for example, various categories of web pages via the communication network 7.

The server 3 provides information in response to a request from an application executed in the wireless terminal 5. For example, if the application executed in the wireless terminal 5 is a browser, the server 3 provides a web page in response to the request from the application of the wireless terminal 5. The browser of the wireless terminal 5, after having received information on the web page (e.g., HTML) from the server 3, transmits to the advertisement delivery apparatus 4 the advertising request corresponding to the advertising space set in the web page. This causes the wireless terminal 5 to acquire, from the advertisement delivery apparatus 4, and display the advertising information set in the advertising space of the web page.

The advertising request serves as a delivery request for advertising information to be displayed on the advertising space. The advertising request includes, for example, identification information on the user U having the wireless terminal 5 (hereinafter, a user ID) and identification information on the advertising space (hereinafter, an advertising space ID). The user ID is included, for example, in a HyperText Transfer Protocol cookie (HTTP cookie; hereinafter, a cookie). Such a cookie can also include user information such as age and sex of the user U in addition to the user ID.

It is noted that the server 3 may acquire, from the advertisement delivery apparatus 4, advertising information corresponding to the user ID of the user U having the wireless terminal 5 that has made access to the server 3 and embed such advertising information in the web page to thereby provide the wireless terminal 5 with the advertising information. The user ID of the user U is, for example, a login ID to be used to log onto the server 3.

The wireless terminal 5 has, for example, a wireless LAN communication function similarly to a smartphone or a mobile PC, capable of communicating with the wireless apparatus 6 or a wireless WAN base station (not illustrated). It is noted that the wireless WAN base station is, for example, a portable telephone base station of a portable telephone communication network and is connected to the communication network 7.

For example, a browser, a game, and a content reproducing player are installed in the wireless terminal 5. The control unit of the wireless terminal 5, for example, acquires application program data provided from the advertisement delivery apparatus 4 or the server 3 via the communication network 7 and loads the program data in an internal storage to thereby make the application executable. Through execution of the application, the control unit of the wireless terminal 5 accesses the server 3 and acquires the advertising information directly from the advertisement delivery apparatus 4 or by way of the server 3, thereby displaying the advertising information on the display.

The wireless apparatus 6 is, for example, a wireless LAN access point. If the wireless terminal 5 can transmit a terminal ID through near field communication (NFC), however, the wireless apparatus 6 may be an NFC apparatus. The NFC covers a communication area extending over about one meter to several centimeters. Examples of the NFC include Felica and ISO/IEC14443 (MIFARE). Communication by the NFC is not limited only to radio waves. Alternatively, for example, infrared rays, visible rays, and sound waves may be used.

A configuration of the wireless apparatus 6 will first be described below, followed by a description of a configuration of the advertisement delivery apparatus 4.

2.1 Configuration of Wireless Apparatus 6

The configuration of the wireless apparatus 6 will be described in detail below. FIG. 3 is a diagram illustrating an exemplary configuration of the wireless apparatus 6. As illustrated in FIG. 3, the wireless apparatus 6 is a wireless LAN access point and includes a wireless LAN communication unit 21, a WAN communication unit 22, a control unit 23, and a storage unit 24.

The wireless LAN communication unit 21 is disposed such that a site corresponding to the partner company C (e.g., within a store of the partner company C or an area therearound) is covered by a wireless communication area thereof (hereinafter, AP communication area). The wireless LAN communication unit 21 is a communication interface that performs wireless LAN communication, transmitting and receiving information to and from the wireless terminal 5 on which a wireless LAN communication function is mounted. The wireless LAN may, for example, be one specified by IEEE802.11. The wireless LAN compatible with the foregoing standard is not, however, the only possible choice.

The WAN communication unit 22 is connected to the communication network 7 and transmits and receives information to and from the information management apparatus 2, the server 3, and the advertisement delivery apparatus 4 over the communication network 7. The connection between the WAN communication unit 22 and the communication network 7 may be hard-wired or wireless.

The control unit 23 includes a relay unit 25 that relays information and a detecting unit 26 that detects the wireless terminal 5. The control unit 23 performs the information processing functions and effects to be described below. Additionally, the control unit 23 is achieved by an integrated circuit, such as an application specific integrated circuit (ASIC) and a field programmable gate array (FPGA).

The control unit 23 functions as the relay unit 25 and the detecting unit 26 when an internal central processing unit (CPU) or micro processing unit (MPU) performs a computer program stored in an internal storage using a RAM as a work space. It is noted that the internal configuration of the control unit 23 described above is not the only one possibility, and the control unit 23 may be configured otherwise as long as the control unit 23 can perform information processing to be described later.

The relay unit 25, for example, transmits information acquired from the wireless terminal 5 via the wireless LAN communication unit 21, from the WAN communication unit 22 to the server 3 or the advertisement delivery apparatus 4. The relay unit 25 also transmits information acquired from the server 3 or the advertisement delivery apparatus 4 via the WAN communication unit 22, from the wireless LAN communication unit 21 to the wireless terminal 5.

Transmission of information from the wireless apparatus 6 to the server 3 or the advertisement delivery apparatus 4 is performed, for example, through packet communication that defines an address of the communication network 7 assigned to the wireless apparatus 6 as a transmitter address and an address of the communication network 7 assigned to the server 3 or the advertisement delivery apparatus 4 as a receiver address. The address of the communication network 7 is, for example, an address assigned to the WAN communication unit 22.

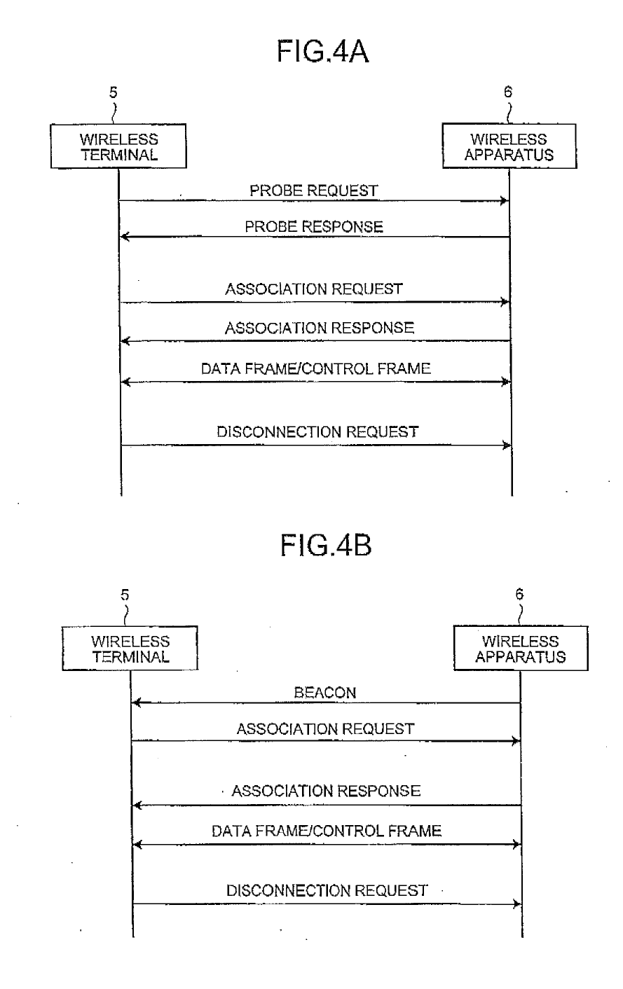

The detecting unit 26 acquires via the wireless LAN communication unit 21 information on a wireless packet (an exemplary wireless signal) transmitted from the wireless terminal 5 to thereby detect presence of the wireless terminal 5. FIGS. 4A and 4B are exemplary sequence diagrams for establishing a session between the wireless apparatus 6 and the wireless terminal 5. The sequence for establishing the session is not limited only to the examples illustrated in FIGS. 4A and 4B.

The example illustrated in FIG. 4A illustrates that a wireless packet called a probe request is transmitted by broadcast or the like from the wireless terminal 5 at regular intervals. The detecting unit 26 acquires information on the wireless packet via the wireless. LAN communication unit 21 to thereby detect presence of the wireless terminal 5.

The probe request includes a service set identifier (SSID). If the SSID included in the probe request matches an SSID of the wireless LAN communication unit 21, the detecting unit 26 transmits a probe response to the wireless terminal 5. When receiving the probe response, the wireless terminal 5 shifts into a communication state, if automatic communication has been set. The shift into the communication state is achieved by establishing a session using an association request and an association response as illustrated in FIG. 4A. Thereafter, a data frame and a control frame are transmitted or received between the wireless terminal 5 and the wireless LAN communication unit 21 to thereby cause the communication state to be started.

Additionally, the detecting unit 26 broadcasts via the wireless LAN communication unit 21 a wireless packet called a beacon, as illustrated in FIG. 4B, to the wireless terminal 5 to which the wireless packet is not transmitted at regular intervals. On receipt of an association request relative to the beacon, the detecting unit 26 detects presence of the wireless terminal 5. The detecting unit 26, having received the association request, transmits an association response to the wireless terminal 5 to thereby establish a session in which the wireless terminal 5 and the wireless LAN communication unit 21 are communicating with each other.

The communication state is canceled when a disconnection request is received or when a wireless packet cannot be transmitted or received between the wireless terminal 5 and the wireless LAN communication unit 21. The detecting unit 26 repeatedly receives wireless packets to thereby detect presence of the wireless terminal 5 until the communication state is canceled.

The detecting unit 26, when, for example, determining that the wireless terminal 5 has been detected, transmits the entry information to the advertisement delivery apparatus 4 via the WAN communication unit 22 and the communication network 7. Specifically, the detecting unit 26 extracts the terminal ID included in the wireless packet transmitted from the wireless terminal 5 and further detects radio wave strength.

The terminal ID is, for example, a MAC address of a wireless LAN communication unit of the wireless terminal 5 and transmitted from the wireless terminal 5 by being appended to the wireless packet. The radio wave strength represents that of the wireless signal received by the wireless apparatus 6. It is noted that the radio wave strength may be received signal strength indication (RSSI) acquired in the wireless terminal 5. In this case, a wireless signal including information on the radio wave strength is transmitted from the wireless terminal 5 to the wireless apparatus 6.

The detecting unit 26 transmits, in addition to the terminal ID of the wireless terminal 5 and the radio wave strength information, information including the business ID and the store ID as entry information to the advertisement delivery apparatus 4 at regular intervals (e.g., every one second). The store ID is identification information for the store in which the wireless apparatus 6 is installed. A network address of the communication network 7 assigned to the WAN communication unit 22 may, for example, be used as the store ID. It is noted that the store ID does not necessarily have to be a network address as long as the store can be identified by the store ID. Additionally, the entry information may be arranged to be transmitted to the advertisement delivery apparatus 4 via the information management apparatus 2.

2.2 Advertisement Delivery Apparatus 4

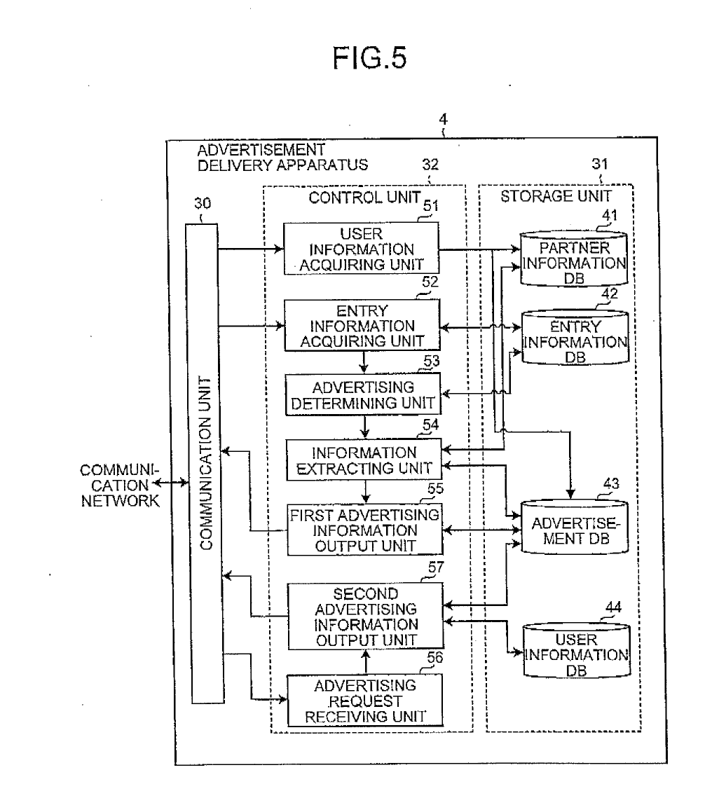

The configuration of the advertisement delivery apparatus 4 will be described in detail below. FIG. 5 is a diagram illustrating an exemplary configuration of the advertisement delivery apparatus 4. As illustrated in FIG. 5, the advertisement delivery apparatus 4 includes a communication unit 30, a storage unit 31, and the control unit 32.

The storage unit 31 includes a partner information DB 41 (an exemplary company information DB), an entry information DB 42, an advertisement DB 43, and a user information DB 44. The control unit 32 includes a user information acquiring unit 51, an entry information acquiring unit 52, an advertising determining unit 53, an information extracting unit 54, a first advertising information output unit 55, an advertising request receiving unit 56, and a second advertising information output unit 57. The configuration of the control unit 32 described above is not the only one possibility, and the control unit 32 may be configured otherwise as long as the configuration enables information processing to be described later to be performed.

The communication unit 30 is an interface such as a network interface card (NIC). The control unit 32 can transmit and receive various types of information to and from the information management apparatus 2, server 3, the wireless terminal 5, and the wireless apparatus 6 via the communication unit 30 and the communication network 7.

2.2.1 User Information Acquiring Unit 51

The user information acquiring unit 51 acquires from the information management apparatuses 2₁, 2₂ user information owned by each of the partner companies CA, CB and stores the user information in the partner information DB 41. The user information is updated on a real-time basis or at regular intervals in each partner company C and the user information acquiring unit 51 acquires the updated user information to thereby update the user information in the partner information DB 41.

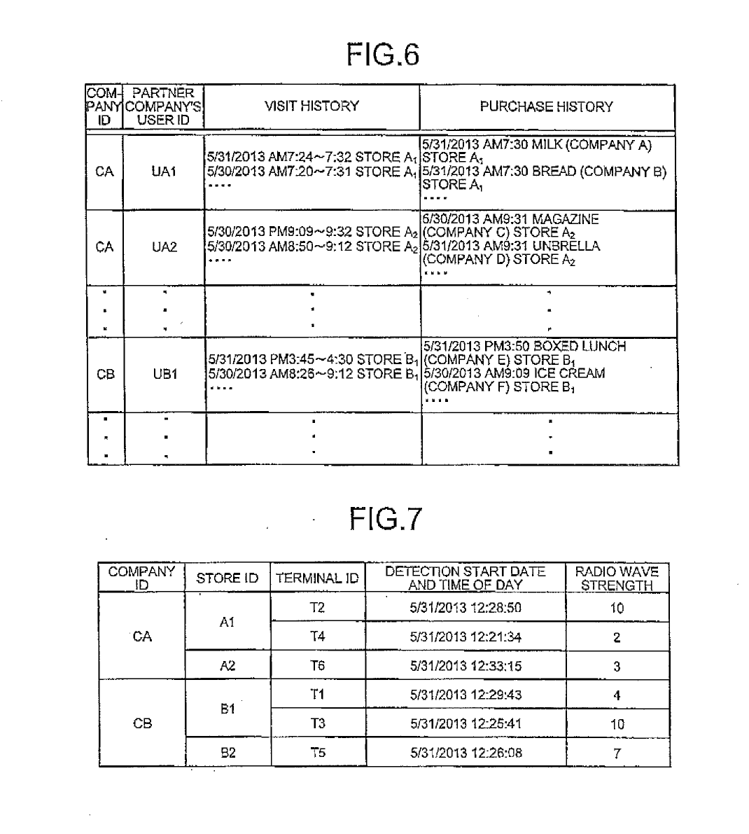

FIG. 6 is a diagram illustrating an exemplary partner company's user information table stored in the partner information DB 41. As illustrated in FIG. 6, the partner company's user information table provides information on the behavior history information such as “business ID”, “partner company's user ID”, “visit history”, and “purchase history”, each being associated with each other.

The “business ID” is identification information for the partner company C. In the example illustrated in FIG. 6, “CA” is the business ID of the partner company CA and “CB” is the business ID of the partner company CB. It is noted that, although the example illustrated in FIG. 6 sets both the user information on the partner company CA and the user information on the partner company CB on the same partner company's user information table, management of the user information on the partner company C is not limited only to such a configuration.

For example, one partner company's user information table may be set for each partner company C, so that the user information can be set on the partner company's user information table corresponding to each partner company C. A partner information DB may even be set for each partner company C. This allows the user information to be managed for each partner company C.

The “partner company's user ID” is a user ID unique to each partner company C and assigned to the user U who uses the partner company C. In the example illustrated in FIG. 6, “UA1”, “UA2”, and the like are assigned in the partner company CA and “UB1” and the like are assigned in the partner company CB. It is noted that the set of the business ID and the partner company's user ID only needs to be unique information, and the partner company's user ID of the partner company CA and the partner company's user ID of the partner company CB may be duplicated.

The “visit history” is a history of visits made by the user U relative to, for example, a store of the partner company C. For example, as illustrated in FIG. 6, the “visit history” includes information such as the date and time of day of the visit and a specific store visited by the user U. The “purchase history” is a history of purchases made by the user U at the store of the partner company C. For example, as illustrated in FIG. 6, the “purchase history” includes information such as the date and time of day of the purchase made, a specific commodity the user U purchased (including a manufacturer name and a commodity name), and a specific store at which the user U purchased the commodity.

The types of user information on the partner company C are not limited only to those illustrated in FIG. 6. For example, age, sex, favorite items, visit frequency, and an average value of purchases may constitute the information. Each partner company C may even set unique types of information for the user information.

2.2.2 Entry Information Acquiring Unit 52

The entry information acquiring unit 52 acquires entry information from the wireless apparatus 6 that covers a site corresponding to the partner company C as the AP communication area. If the entry information is transmitted from the wireless apparatus 6 via the information management apparatus 2, the entry information acquiring unit 52 may acquire the entry information from the information management apparatus 2.

The entry information acquiring unit 52 updates a terminal detection table in the entry information DB 42 based on the business ID, the store ID, the terminal ID, and the radio wave strength information included in the entry information.

FIG. 7 is a diagram illustrating an exemplary terminal detection table. As illustrated in FIG. 7, the terminal detection table includes information on “business ID”, “store ID”, “terminal ID”, “detection start date and time of day”, and “radio wave strength”, each being associated with each other. The “business ID” is identification information for the partner company C. The “store ID” is identification information for the store in which the wireless apparatus 6 is installed. The “store ID” may, for example, be a network address of the wireless apparatus 6. The “terminal ID” is identification information for the wireless terminal 5 detected by the wireless apparatus 6. The “terminal ID” may, for example, be a MAC address of the wireless LAN communication unit of the wireless terminal 5.

The “detection start date and time of day” represents the time of day at which the wireless terminal 5 is detected in the AP communication area (detection start time of day). The “radio wave strength” is the radio wave strength of the wireless packet of the wireless terminal 5 detected by the wireless apparatus 6. The “radio wave strength” may, for example, be average radio wave strength since the detection start time of day.

2.2.3 Advertising Determining Unit 53

The advertising determining unit 53 determines, based on the entry information set in the terminal detection table in the entry information DB 42, whether the wireless terminal 5 that has entered a site corresponding to the partner company C is an advertising object.

The advertising determining unit 53 determines the wireless terminal 5 that has entered the site corresponding to the partner company C to be the advertising object, if the time period of stay and the radio wave strength of the wireless terminal 5 present in the AP communication area satisfy previously set determining conditions based on the terminal detection table in the entry information DB 42.

For example, the advertising determining unit 53 determines a wireless terminal 5 to be the advertising object, if, with respect to the wireless terminal 5, the time period of stay in the AP communication area is equal to, or longer than, a time threshold value and the radio wave strength is equal to, or greater than, a strength threshold value. In contrast, if, relative to a wireless terminal 5, for example, the time period of stay in the AP communication area is less than the time threshold value and the radio wave strength is less than the strength threshold value, the advertising determining unit 53 does not determine the wireless terminal 5 to be the advertising object.

The advertising determining unit 53 can detect the time period of stay of the wireless terminal 5 within the AP communication area by comparing the detection start time of day set in the terminal detection table with the current time of day. The advertising determining unit 53 may still determine the type of entry state of the user U, such as staying in the store, and passing by or walking around the area outside the store, according to the time period of stay in the AP communication area and the radio wave strength.

The advertising determining unit 53, when determining that the wireless terminal 5 has entered the site corresponding to the partner company C, notifies the information extracting unit 54 of an information extraction instruction. The information extraction instruction includes the business ID, the store ID, the terminal ID, and entry state information. The entry state information indicates the type of the entry state described above.

The threshold value information including the time threshold value and the strength threshold value described above can be adjusted for each store ID or terminal ID. For example, the setting values of the threshold value information for each store can be transmitted from the information management apparatus 2 or a terminal apparatus (not illustrated) or the wireless terminal 5 to the advertisement delivery apparatus 4, so that the advertising determining unit 53 stores the threshold value information acquired via the communication unit 30 in the entry information DB 42.

2.2.4 Information Extracting Unit 54

The information extracting unit 54, when having received an information extraction instruction from the advertising determining unit 53, selects an advertising mode based on the terminal ID of the wireless terminal 5 included in the information extraction instruction and extracts, from the partner information DB 41, user information corresponding to the selected advertising mode. The advertising mode may be either a targeting mode or a retargeting mode.

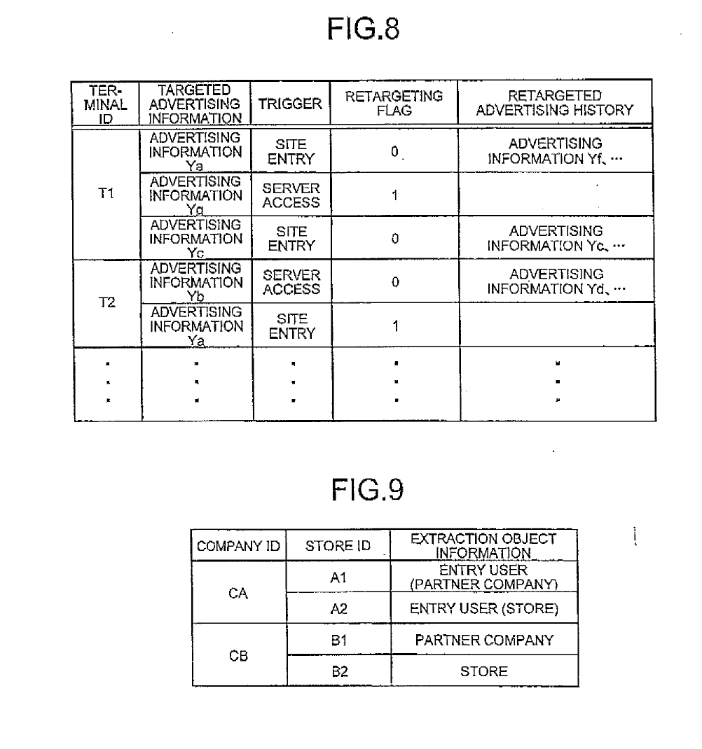

The advertising mode is selected based on an advertisement delivery history table (an exemplary output history of advertising information) stored in the advertisement DB 43. FIG. 8 is a diagram illustrating an exemplary advertisement delivery history table. As illustrated in FIG. 8, the advertisement delivery history table provides information on “targeted advertising information”, “trigger”, “retargeting flag”, and “retargeted advertising history”, associated with each other for each “terminal ID”.

The “targeted advertising information” represents the advertising information output from the advertisement delivery apparatus 4 to the wireless terminal 5 having the corresponding terminal ID in the targeting mode. It should be noted that the “targeted advertising information” identifies the advertising information (e.g., an advertisement ID to be described later). The “trigger” indicates a trigger of the targeted advertising information (exemplary first advertising information). A “site entry” is set for the “trigger”, if the targeted advertising information is delivered based on entry information. A “server access” is set for the “trigger”, if the targeted advertising information is delivered based on access to the server 3.

A “1” or a “0” is set for the “retargeting flag”. The information extracting unit 54 selects the advertising mode based on the “retargeting flag” and the “trigger” associated with the terminal ID of the wireless terminal 5 included in the entry information.

Specifically, the information extracting unit 54 selects the retargeting mode, if the “targeted advertising information” having a “server access” set for the “trigger” and a “1” set for the “retargeting flag” is associated with the terminal ID of the wireless terminal 5 included in the information extraction instruction.

Assume, for example, that the advertisement delivery history table is as illustrated in FIG. 8. In this case, when the terminal ID of the wireless terminal 5 included in the information extraction instruction is “T1”, the information extracting unit 54 selects the retargeting mode because the advertisement delivery history table contains “advertising information Ya” that has a “server access” set for the “trigger” and a “1” set for the “retargeting flag”.

The information extracting unit 54, if not selecting the retargeting mode, selects the targeting mode. For example, when the terminal ID of the wireless terminal 5 included in the information extraction instruction is “T2”, the information extracting unit 54 selects the targeting mode because the advertisement delivery history table contains no “targeted advertising information” that has a “server access” set for the “trigger” and a “1” set for the “retargeting flag”.

The “retargeted advertising history” represents a history of advertising information output from the advertisement delivery apparatus 4 to the wireless terminal 5 having the corresponding terminal ID in the retargeting mode. The “retargeted advertising history” includes, for example, a behavior history of the user U based on the advertising information (e.g., conversion of a commodity or service as the object of the advertising information), in addition to information indicating the output advertising information (e.g., an advertisement ID to be described later). The behavior history of the user U is, for example, collected by the user information acquiring unit 51 from the server 3 or the information management apparatus 2 and stored in the advertisement delivery history table.

The following describes information extraction performed by the information extracting unit 54 specifically when the targeting mode is selected and when the retargeting mode is selected.

2.2.4.1 Targeting Mode

The following describes the information extraction in the targeting mode. When the targeting mode is selected, the information extracting unit 54 extracts, from the partner information DB 41, the user information on the partner company C corresponding to the site which the wireless terminal 5 has entered based on the information extraction instruction notified from the advertising determining unit 53.

Specifically, the information extracting unit 54 identifies extraction object information based on the business ID and the store ID including in the information extraction instruction. The extraction object information is identified based on a partner company information table stored in the partner information DB 41.

FIG. 9 is a diagram illustrating an exemplary partner company information table. As illustrated in FIG. 9, the partner company information table includes information on “store ID” and “extraction object information” associated with “business ID”. The extraction object information is set in the partner company information table by the user information acquiring unit 51 in response to, for example, a request made from an apparatus of the partner company C (e.g., the information management apparatuses 2₁, 2₂).

In the example illustrated in FIG. 9, “entry user (partner company)” is associated as the “extraction object information” with the store ID “A1”, “entry user (store)” is associated as the “extraction object information” with the store ID “A2”, “partner company” is associated as the “extraction object information” with the store ID “B1”, and “store” is associated as the “extraction object information” with the store ID “B2”.

The “entry user (partner company)” is the setting for extracting “of the user information on the entry user U, user information on the partner company C which the entry user U has entered”. The “entry user (store)” is the setting for extracting “of the user information on the entry user U, user information on the store which the entry user U has entered”. The “partner company” is the setting for extracting “all user information on the partner company C which the entry user U has entered”. The “store” is the setting for extracting “all user information on the store which the entry user U has entered”.

If the extraction object information associated with the business ID and the store ID is “entry user (partner company)” or “entry user (store)”, the information extracting unit 54 identifies the user ID of the partner company C (partner company's user ID) corresponding to the site which the wireless terminal 5 has entered based on the terminal ID included in the information extraction instruction. The identification is performed based on a correspondence information table stored in the advertisement DB 43.

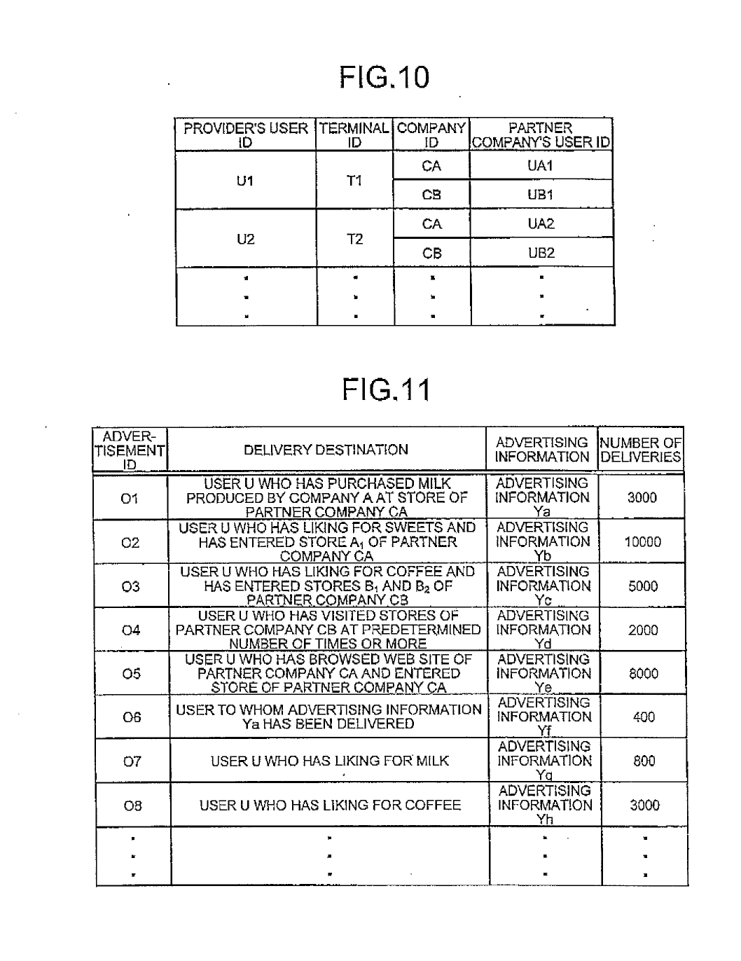

FIG. 10 is a diagram illustrating an exemplary correspondence information table. As illustrated in FIG. 10, the correspondence information table includes information on “terminal ID”, “business ID”, and “partner company's user ID” associated with each “provider's user ID”. The “provider's user ID” is user U identification information set by the advertisement delivery service provider and may, for example, be the login ID for the server 3. If, for example, the information extraction instruction includes the terminal ID “T1” and the business ID “CA”, the information extracting unit 54 determines the partner company's user ID to be “UA1” and the provider's user ID to be “U1”.

Having identified the extraction object information and the partner company's user ID based on the information extraction instruction, the information extracting unit 54 extracts user information from the partner information DB 41. Specifically, if the business ID is “CA”, the extraction object information is “entry user (partner company)”, and the partner company's user ID is “UA1”, the information extracting unit 54 extracts, of the user information on the partner company CA, user information with the partner company's user ID “UA1” from the partner company's user information table.

If the business ID is “CA”, the store ID is “A1”, the extraction object information is “entry user (store)”, and the partner company's user ID is “UA1”, the information extracting unit 54 extracts, of the user information on the partner company CA, user information associated with the partner company's user ID “UA1” and including information on “store A₁” from the partner company's user information table.

If the business ID is “CA” and the extraction object information is “partner company”, the information extracting unit 54 extracts all user information on the partner company CA from the partner company's user information table. If the business ID is “CA”, the store ID is “A1”, and the extraction object information is “store”, the information extracting unit 54 extracts, of the user information on the partner company CA, user information including information on “store A₁” from the partner company's user information table.

As described above, the information extracting unit 54 extracts the user information on the partner company C corresponding to the site which the wireless terminal 5 has entered, but not user information on any of those other than the partner company C corresponding to the site which the wireless terminal 5 has entered. Thus, access limit is imposed on user information in units of the partner company C, which can ensure security in units of the partner company C.

It is noted that, when the extraction object information is “entry user (partner company)” or “entry user (store)”, the partner information DB 41 may contain no user information or only a small amount of user information on the entry user U. In such cases, the information extracting unit 54 can extract the corresponding user information from a user information table stored in the user information DB 44. The user information table will be described later.

Having extracted the user information on the partner company C corresponding to the site which the wireless terminal 5 has entered, the information extracting unit 54 appends as additional information the partner company's user XD and the provider's user ID of the entry user U and the business ID and the store ID corresponding to the entry site to the user information and notifies the first advertising information output unit 55 of the user information. Assume a case, for example, in which the user U₁ of the wireless terminal 5₁ with the terminal ID “T1” enters the store A₁ of the partner company CA. In this case, the partner company's user ID “UA1”, the provider's user ID “U1”, the business ID “CA”, and the store ID “A1” are appended as additional information to the user information on the business ID “CA” and the user information appended with the additional information is notified to the first advertising information output unit 55. Alternatively, the additional information included in the user information extracted from the partner information DB 41 may be notified to the first advertising information output unit 55.

The information extracting unit 54 may also notify the first advertising information output unit 55 of the user information to which the entry state information notified from the advertising determining unit 53 is appended as additional information. Alternatively, the first advertising information output unit 55 may even be notified of additional information included in the user information extracted from the partner information DB 41 or the user information DB 44.

The information extracting unit 54 may also determine timing to notify the first advertising information output unit 55 based on the entry state information notified from the advertising determining unit 53. This enables the user information to be extracted at appropriate timing according to the entry state of the user U.

2.2.4.2 Retargeting Mode

The following describes the information extraction in the retargeting mode. When the retargeting mode is selected, the information extracting unit 54 extracts, from the advertisement DB 43, the “targeted advertising information” having a “server access” set for the “trigger” and a “1” set for the “retargeting flag” based on the information extraction instruction notified from the advertising determining unit 53.

The information extracting unit 54, having extracted the targeted advertising information from the advertisement DB 43, notifies the first advertising information output unit 55 of the targeted advertising information to which the information extracting unit 54 appends as additional information the provider's user ID of the entry user U. For example, when the user U₁ of the wireless terminal 5₁ having the terminal ID “T1” enters a store of the partner company C, the first advertising information output unit 55 is notified of the targeted advertising information to which the provider's user ID “U1” is appended as additional information.

2.2.5 First Advertising Information Output Unit 55

The first advertising information output unit 55 extracts, from the advertising information table of the advertisement DB 43, advertising information corresponding to the information notified from the information extracting unit 54 and outputs the advertising information to the wireless terminal 5 as the delivery object.

As described above, when in the targeting mode, the information notified from the information extracting unit 54 includes the user information and, when in the retargeting mode, the information notified from the information extracting unit 54 includes the targeted advertising information. In the following, operations in the targeting mode will first be described, followed by a description of operations in the retargeting mode.

2.2.5.1 Targeting Mode

When in the targeting mode, the first advertising information output unit 55 extracts, from the advertising information table of the advertisement DB 43, advertising information according to the user information extracted by the information extracting unit 54 and outputs the advertising information to the wireless terminal 5 as the delivery destination.

FIG. 11 is a diagram illustrating an exemplary advertising information table. As illustrated in FIG. 11, the advertising information table includes information on “delivery destination”, “advertising information”, and “number of deliveries” associated with “advertisement ID”.

The “advertisement ID” is identification information assigned to each of received delivery requests by an advertising information receiver (not illustrated) of the advertisement delivery apparatus 4. The “delivery destination” represents conditions for the delivery destination specified by the delivery request. The “advertising information” is advertising information on the object to be delivered, including a text advertisement, a still image advertisement, a moving image advertisement, an animation advertisement, and a banner advertisement. The advertising information includes not only image material and program codes for advertisement display, but also data including link information for acquiring the image material and program codes.

The “number of deliveries” is the number of deliveries to be made for the advertising information specified by the delivery request. It is noted that the advertising information table includes the delivery conditions such as a delivery period specified by the delivery request and information on the commodity or service as the advertising object and on the advertiser. The example illustrated in FIG. 11, however, omits these pieces of information.

In addition, as illustrated in FIG. 11, the advertising information table allows the following to be set as conditions for the “delivery destination”. Specifically, the conditions may, for example, be such that: the user U has a liking for a specific commodity and enters a store of the partner company C; the user U has purchased a specific commodity at a store of the partner company C; and the user U has visited a specific store of the partner company C a predetermined number of times or more. Additionally, the advertising information table also allows the user U who has browsed the web site of the partner company C to be set as the “delivery destination”.

Assume, for example, a case in which the partner company's user information table is as illustrated in FIG. 6 and the advertising information table is as illustrated in FIG. 11. If the user information notified from the information extracting unit 54 is that of the partner company's user ID “UA1”, the first advertising information output unit 55 extracts, for example, the “advertising information Ya” with the advertisement ID “O1” from the advertising information table, because the user information includes a purchase history of “milk (company A)”.

Assume, for example, another case in which the entry user U has a liking for “sweets” as identified from the purchase history of the user information and the business ID and the store ID included in the additional information are “CA” and “A1”, respectively. In this case, the first advertising information output unit 55 extracts, for example, the “advertising information Yb” with the advertisement ID “O2” from the advertising information table.

Assume, for example, still another case in which the entry user U has a liking for “coffee” as identified from the purchase history of the user information and the business ID and the store ID included in the additional information are “CB” and “B1” or “B2”, respectively. In this case, the first advertising information output unit 55 extracts, for example, the “advertising information Yc” with the advertisement ID “O3” from the advertising information table.

Assume, for example, a further case in which a frequency of visit by the entry user U to a store of the partner company CB as identified from the purchase history of the user information is equal to, or greater than, a predetermined value. In this case, the first advertising information output unit 55 extracts, for example, the “advertising information Yd” with the advertisement ID “O4” from the advertising information table.

Assume, for example, a still further case in which the user information notified from the information extracting unit 54 represents all user information on the partner company C corresponding to the site which the entry user U has entered, or user information on the store which the entry user U has entered. In this case, the first advertising information output unit 55 extracts advertising information from the advertising information table based on these pieces of user information.

For example, the first advertising information output unit 55 determines business status of the partner company C from the user information extracted by the information extracting unit 54 and extracts, from the advertising information table, advertising information related to the business status thus determined. The business status of the partner company C determined by the first advertising information output unit 55 includes, for example, a category of business of the partner company C, and types, details, and volumes of commodities and services provided by the partner company C.

In this manner, the first advertising information output unit 55 can select advertising information based on the user information on the partner company C. The delivery of the advertisement can thereby be targeted at the user U related to the partner company C, which enables targeted advertising with high accuracy.

The first advertising information output unit 55, after having output the advertising information, sets the output advertising information or advertisement ID in the advertisement delivery history table. At this time, the first advertising information output unit 55 sets a “site entry” for the “trigger” and a “1” for the “retargeting flag” in the newly set advertising information.

The first advertising information output unit 55, if unable to select the advertising information based on the user information extracted by the information extracting unit 54, may select the advertising information based on the additional information. In this case, the first advertising information output unit 55 acquires, for example, from the user information table of the user information DB 44, user information associated with the provider's user ID included in the additional information to thereby use the user information.

Alternatively, the first advertising information output unit 55 may even select the advertising information based on the entry state information. For example, the first advertising information output unit 55 can select advertising information that specifies as the delivery condition the “time period of stay in the store”, “passing by the area around the store”, or “walking around the area outside the store” based on the entry state information.

2.2.5.2 Retargeting Mode

When in the retargeting mode, the first advertising information output unit 55 extracts, from the advertising information table of the advertisement DB 43, advertising information related to the targeted advertising information extracted by the information extracting unit 54 (hereinafter, retargeted advertising information) and outputs the retargeted advertising information to the wireless terminal 5 as the delivery destination.

The retargeted advertising information (exemplary second advertising information) includes, for example, advertising information related to the commodity or service as the object of the targeted advertising information. For example, when the targeted advertising information is the “advertising information Yg” associated with the advertisement ID “O7” illustrated in FIG. 11, the first advertising information output unit 55 extracts the “advertising information Yg” from the advertisement DB 43 and outputs the “advertising information Yg” to the wireless terminal 5 as the delivery destination.

In this case, the first advertising information output unit 55 may extract, in place of the “advertising information Yg”, other advertising information intended for the commodity or service identical to that of the “advertising information Yg” from the advertisement DB 43 and output the advertising information to the wireless terminal 5 as the delivery destination. Still alternatively, the first advertising information output unit 55 may extract, in place of the “advertising information Yg”, other advertising information intended for a commodity or service similar to that of the “advertising information Yg” from the advertisement DB 43 and output the advertising information to the wireless terminal 5 as the delivery destination.

The retargeted advertising information includes advertising information intended for another commodity or another type of service of the business that provides the commodity or service as the object of the targeted advertising information. Assume, for example, a case in which the targeted advertising information is intended for a commodity or service of company A as the advertiser. In this case, the first advertising information output unit 55 may extract, from the advertisement DB 43, advertising information intended for another commodity or another type of service of company A and output the advertising information to the wireless terminal 5 as the delivery destination. The advertising information table also contains information on the commodity or service as the advertising object and on the advertiser. The first advertising information output unit 55 identifies the commodity or service as the advertising object and the advertiser based on the advertising information table.

The first advertising information output unit 55, after having output the retargeted advertising information, sets information indicating the retargeted advertising information (e.g., the advertisement ID) in the “retargeted advertising history” of the advertisement delivery history table. Additionally, when the number of times the retargeted advertising information is output reaches a predetermined value, the first advertising information output unit 55 changes the “retargeting flag” set on the advertisement delivery history table from “1” to “0”.

The “retargeting flag” is changed from “1” to “0” when, for example, an advertising effect by the retargeted advertising information satisfies a predetermined condition. For example, when the retargeted advertising information is coupon information, the purchase of a commodity or service using the coupon information is considered such that the advertising effect satisfies the predetermined condition. In addition, for example, cost per acquisition (CPA) by the retargeted advertising information being equal to or greater than a predetermined value is considered such that the advertising effect satisfies the predetermined condition. The information on the purchase of the commodity or service, the CPA, and the like are determined by the user information acquiring unit 51 and the first advertising information output unit 55 based on the user information acquired by the information management apparatus 2 and the information acquired by the server 3 to thereby enable updating of the “retargeting flag”.

2.2.6 Advertising Request Receiving Unit 56

The advertising request receiving unit 56 accepts an advertising request transmitted from the wireless terminal 5 or the server 3. The advertising request includes information on the user ID and the advertising space. The user ID is, for example, the provider's user ID.

The advertising request receiving unit 56 acquires information included in the advertising request (hereinafter, advertising request information) and notifies the second advertising information output unit 57 of the advertising request information.

2.2.7 Second Advertising Information Output Unit 57

When notified of the advertising request information from the advertising request receiving unit 56, the second advertising information output unit 57 selects the advertising mode based on the provider's user ID included in the advertising request information and extracts user information from the partner information DB 41 based on the selected advertising mode. The advertising mode may be either the targeting mode or the retargeting mode.

As with the case of the information extracting unit 54, the advertising mode is selected based on the advertisement delivery history table (see FIG. 8) stored in the advertisement DB 43. The second advertising information output unit 57 selects the advertising mode based on the “retargeting flag” and the “trigger” associated with the terminal ID that corresponds to the provider's user ID included in the advertising request information.

Specifically, the second advertising information output unit 57 selects the retargeting mode when, in the advertisement delivery history table, the “targeted advertising information” having a “site entry” set for the “trigger” and a “1” set for the “retargeting flag” is associated with the terminal ID that corresponds to the provider's user ID included in the advertising request information.

For example, assume that the advertisement delivery history table is as illustrated in FIG. 8. In this case, when the terminal ID of the wireless terminal 5 included in the advertising request information is “T2”, the second advertising information output unit 57 selects the retargeting mode because the advertisement delivery history table contains the “advertising information Yg” that has a “site entry” set for the “trigger” and a “1” set for the “retargeting flag”.

The second advertising information output unit 57, if not selecting the retargeting mode, selects the targeting mode. For example, when the terminal ID of the wireless terminal 5 included in the advertising request information is “T1”, the second advertising information output unit 57 selects the targeting mode because the advertisement delivery history table contains no “targeted advertising information” that has a “site entry” set for the “trigger” and a “1” set for the “retargeting flag”.

The following describes information extraction performed by the second advertising information output unit 57 specifically when the targeting mode is selected and when the retargeting mode is selected.

2.2.7.1 Targeting Mode

When the targeting mode is selected, the second advertising information output unit 57 extracts, based on the advertising request information notified from the advertising request receiving unit 56, from the advertisement DB 43, advertising information associated with the provider's user ID of the user U having the wireless terminal 5 that has accessed the server 3 and outputs the advertising information to the wireless terminal 5 as the delivery destination.

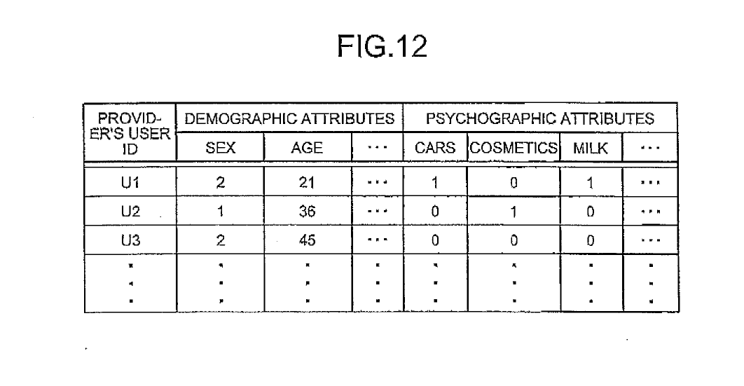

FIG. 12 is a diagram illustrating an exemplary user information table. As illustrated in FIG. 12, the user information table includes information on “demographic attributes” and “psychographic attributes” associated with each “provider's user ID”. The user information table may even contain an access log of accesses to the server 3 managed by the advertisement delivery service provider, the access log being associated with each “provider's user ID”.

The “demographic attributes” represents information on demographic attributes of the user U. The “demographic attributes” may be classified into attribute categories of, for example, “sex” and “age” of the user U. For the “sex”, a “1” is stored if the user U is a female and a “2” is stored if the user U is a male. For the “age”, the age of the user U is stored. The “demographic attributes” may even include various other attribute categories, such as occupation, family structure, annual income, address, birthplace, and academic background of the user U, in addition to those exemplarily illustrated in FIG. 12.

The “psychographic attributes” represents information indicating sense of values, lifestyle, personality, preference, and the like of the user U. The “psychographic attributes” may be classified into attribute categories of, for example, “cars”, “cosmetics”, and “milk”. In the example illustrated in FIG. 12, relative to each attribute category, a “1” is stored if the user U has a relatively high liking and a “0” is stored otherwise. The “psychographic attributes” may even include various other attribute categories, such as economy, politics, sports including baseball and soccer, sweets, personal computers, large household electrical appliances, and furniture, in addition to those exemplarily illustrated in FIG. 12. In addition, the user information table includes, for example, an access history of the user U accessing the server 3.

The second advertising information output unit 57 extracts advertising information from the advertisement DB 43 based on the demographic attributes and the psychographic attributes of the user U having the wireless terminal 5 that has accessed the server 3. For example, the user U with the provider's user ID “U1” illustrated in FIG. 12 has a relatively high liking for “milk”, so that the second advertising information output unit 57 extracts, from the advertisement DB 43, for example, the advertising information Yg with the advertisement ID “O7” illustrated in FIG. 11.

The second advertising information output unit 57 may acquire, from the user information table, an access history of the user U relative to the server 3 to thereby determine behavior of the user U relative to the server 3 (e.g., a page browsing history) from the access history. In this case, the second advertising information output unit 57 extracts the advertising information according to the behavior of the user U from the advertisement DB 43. The second advertising information output unit 57 can also identify preference and behavior of the user U based on the partner company's user information table of the partner information DB 41.

If there is a transmission request for advertising information with a specific provider's user ID specified from the server 3, the second advertising information output unit 57 acquires, from the user information table of the user information DB 44, user information corresponding to the provider's user ID and extracts, from the advertisement DB 43, advertising information according to the user information.

After having output the advertising information, the second advertising information output unit 57 sets information indicating the output advertising information (e.g., an advertisement ID) in an advertisement delivery history table. At this time, the second advertising information output unit 57 sets a “site entry” for the “trigger” and a “1” for the “retargeting flag” in the newly set advertising information.

2.2.7.2 Retargeting Mode

When the retargeting mode is selected, the second advertising information output unit 57 extracts, based on the advertising request information notified from the advertising request receiving unit 56, from the advertisement DB 43, advertising information related to the targeted advertising information set in the advertisement delivery history table and outputs the advertising information to the wireless terminal 5 as the delivery destination.

The retargeted advertising information (exemplary second advertising information) includes, for example, advertising information related to the commodity or service as the object of the targeted advertising information. For example, when the targeted advertising information is the “advertising information Ya” associated with the advertisement ID “O1” illustrated in FIG. 11, the second advertising information output unit 57 extracts the “advertising information Ya” from the advertisement DB 43 and outputs the advertising information to the wireless terminal 5 as the delivery destination.

In this case, the second advertising information output unit 57 may extract, in place of the “advertising information Ya”, other advertising information intended for the commodity or service identical to that of the “advertising information Ya” from the advertisement DB 43 and output the advertising information to the wireless terminal 5 as the delivery destination. Still alternatively, the second advertising information output unit 57 may extract, in place of the “advertising information Ya”, other advertising information intended for a commodity or service similar to that of the “advertising information Ya” from the advertisement DB 43 and output the advertising information to the wireless terminal 5 as the delivery destination.

The retargeted advertising information includes advertising information intended for another commodity or another type of service of the business that provides the commodity or service as the object of the targeted advertising information. Assume, for example, a case in which the targeted advertising information is intended for a commodity or service of company A as the advertiser. In this case, the second advertising information output unit 57 may extract, from the advertisement DB 43, advertising information intended for another commodity or another type of service of company A and output the advertising information to the wireless terminal 5 as the delivery destination. The advertising information table also contains information on the commodity or service as the advertising object and on the advertiser. The second advertising information output unit 57 identifies the commodity or service as the advertising object and the advertiser based on the advertising information table.

As with the first advertising information output unit 55, the second advertising information output unit 57, after having output the retargeted advertising information, sets information indicating the retargeted advertising information (e.g., the advertisement ID) in the “retargeted advertising history” of the advertisement delivery history table. Additionally, as with the first advertising information output unit 55, the second advertising information output unit 57 changes the “retargeting flag” set on the advertisement delivery history table from “1” to “0”, when the advertising effect by the retargeted advertising information satisfies a predetermined condition. The advertising effect by the retargeted advertising information includes, for example, the number of times the targeted advertising information is output, the purchase of the commodity or service, and the CPA.

### 3. Process Procedure Performed by Advertisement Delivery System 1

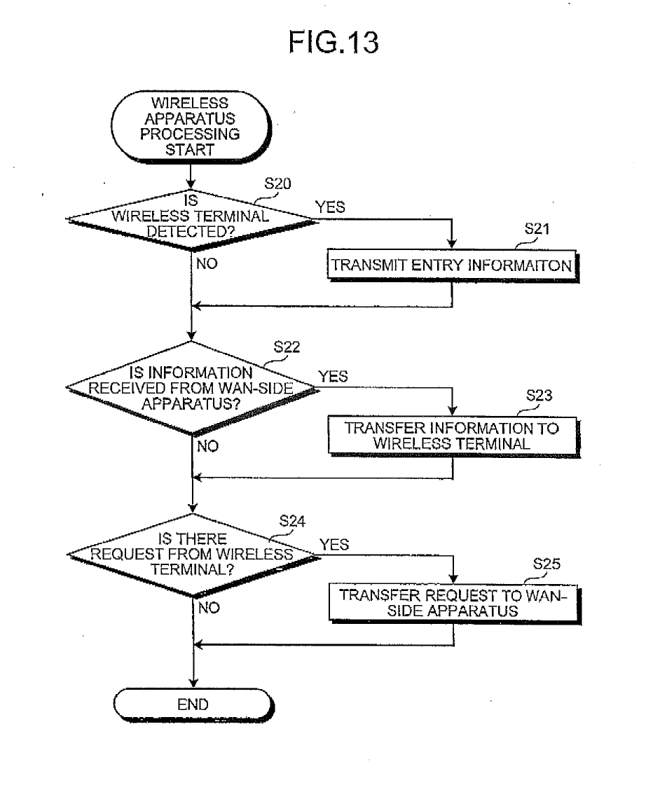

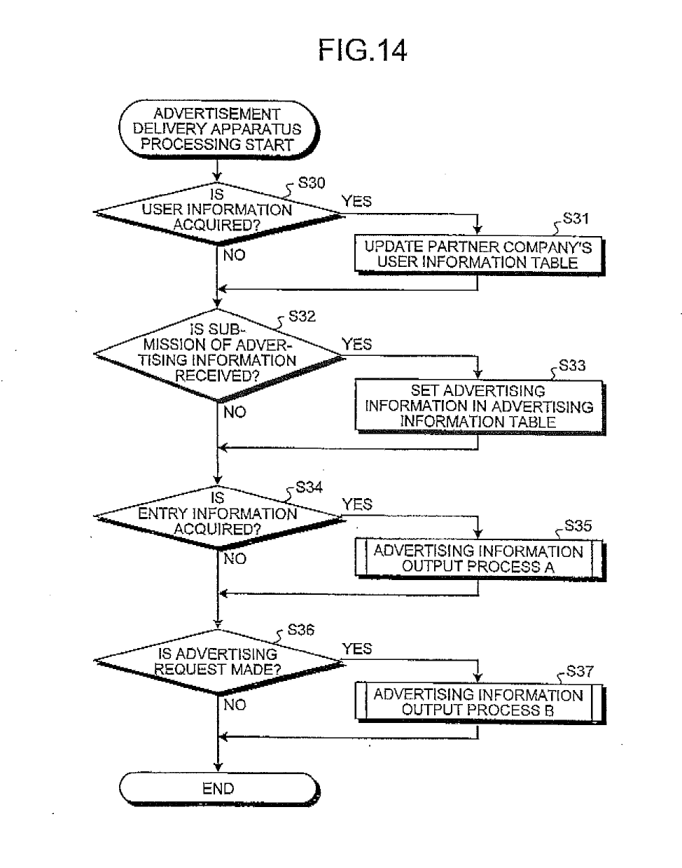

The following describes the procedure of an information providing process performed by the advertisement delivery system 1 according to the embodiment. FIGS. 13 to 16 are flowcharts for illustrating the procedure of the information providing process performed by the advertisement delivery system 1. In the following, information processing performed by the wireless apparatus 6 will be described with reference to FIG. 13 and information processing performed by the advertisement delivery apparatus 4 will be described with reference to FIGS. 14 to 16.

Processing Performed by the Wireless Apparatus 6

The information processing performed by the wireless apparatus 6 according to the embodiment will first be described. FIG. 13 is a flowchart illustrating information processing performed by the wireless apparatus 6 according to the embodiment. The operations are repeatedly performed by the control unit 23 of the wireless apparatus 6.

As illustrated in FIG. 13, the control unit 23 of the wireless apparatus 6 determines whether the wireless terminal 5 is detected (Step S20). If it is determined at this step that the wireless terminal 5 is detected (Yes at Step S20), the entry information is transmitted to the advertisement delivery apparatus 4 via the WAN communication unit 22 (Step S21).

If it is determined at Step S20 that the wireless terminal 5 is not detected (No at Step S20), or if the process at Step S21 is terminated, the control unit 23 determines whether information is received via the WAN communication unit 22 from a WAN-side apparatus connected to communication network 7 (Step S22). The WAN-side apparatus may, for example, be the server 3 and the advertisement delivery apparatus 4. If it is determined that the information is received from the NAN-side apparatus (Yes at Step S22), the control unit 23 transfers the received information to the wireless terminal 5 as the destination of this information (Step S23).

If it is determined at Step S22 that the information is not received (No at Step S22), or if the process at Step S23 is terminated, the control unit 23 determines whether there is a request made from the wireless terminal 5 to the WAN-side apparatus (Step S24). If it is determined that there is a request made from the wireless terminal 5 to the WAN-side apparatus (Yes at Step S24), the control unit 23 transfers, to the WAN-side apparatus via the WAN communication unit 22, the request from the wireless terminal 5 to the WAN-side apparatus (Step S25).

If the process at Step 225 is terminated, or it is determined at Step S21 that there is no request made from the wireless terminal 5 to the WAN-side apparatus (No at Step S24), the control unit 23 terminates the process.

Processing Performed by the Advertisement Delivery Apparatus 4

The following describes the information processing performed by the advertisement delivery apparatus 4 according to the embodiment. FIG. 14 is a flowchart illustrating the information processing performed by the advertisement delivery apparatus 4 according to the embodiment. The operations are repeatedly performed by the control unit 32 of the advertisement delivery apparatus 4.

As illustrated in FIG. 14, the control unit 32 determines whether the user information on the partner company C is acquired from the information management apparatus 2 via the communication unit 30 (Step S30). If it is determined that the user information on the partner company C is acquired (Yes at Step S30), the control unit 32 sets the acquired user information on the partner company's user information table of the partner information DB 41 to thereby update the partner company's user information table (Step S31).

If it is determined at Step 330 that the user information on the partner company C is not acquired (No at Step S30), or if the process at Step S31 is terminated, then the control unit 32 determines whether submission of the advertising information is received from an advertiser's apparatus via the communication unit 30 (Step S32). If it is determined that the submission of the advertising information is received (Yes at Step S32), the control unit 32 sets the received advertising information in the advertising information table of the advertisement DB 43 (Step S33).

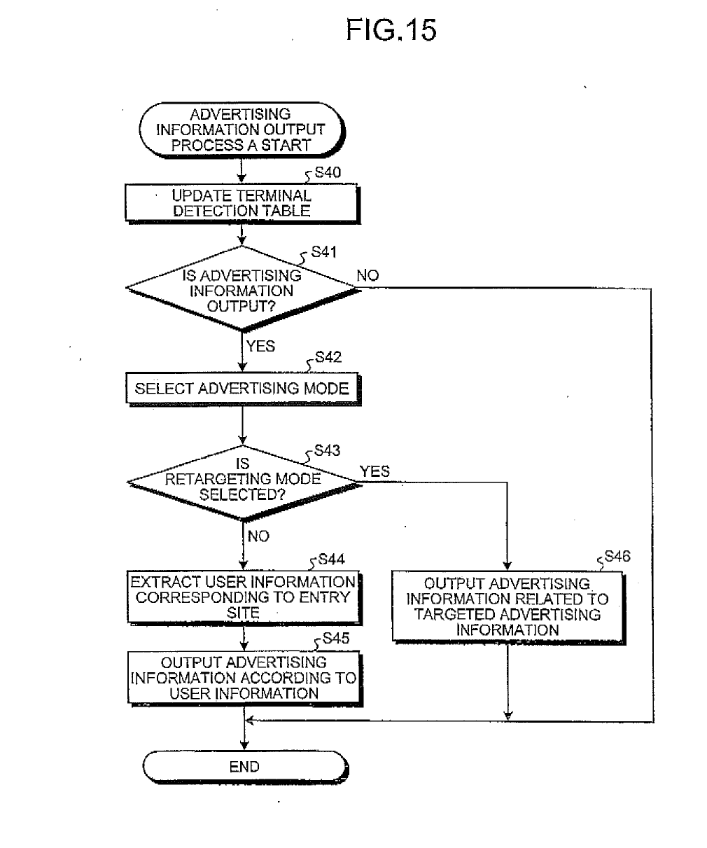

If it is determined that the submission of the advertising information is not received (No at Step S32), or if the process at Step S33 is terminated, then the control unit 32 determines whether the entry information transmitted from the wireless apparatus 6 via the communication unit 30 is acquired (Step S34). If it is determined that the entry information is acquired (Yes at Step S34), the control unit 32 performs an advertising information output process A (Step S35). The advertising information output process A represents the process of Steps S40 to S46 illustrated in FIG. 15 and will be described in detail later.

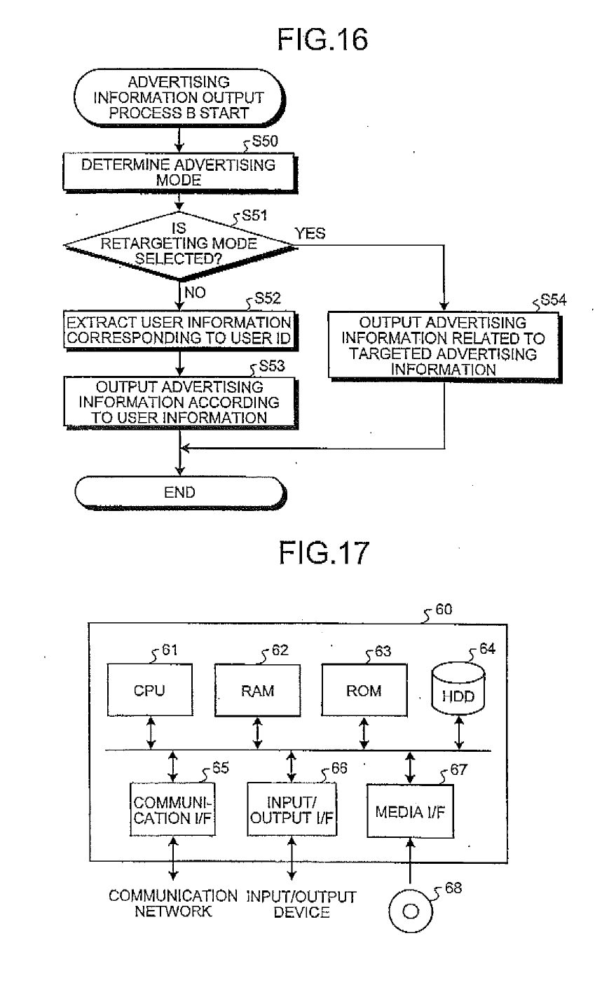

If it is determined at Step S34 that the entry information is not acquired (No at Step S34), or if the process of Step S35 is terminated, then the control unit 32 determines whether an advertising request is from the wireless terminal 5 or the server 3 (Step S36). If it is determined that there is an advertising request (Yes at Step S36), the control unit 32 performs an advertising information output process B (Step S37). The advertising information output process B represents the process of Steps S50 to S54 illustrated in FIG. 16 and will be described later.

If it is determined that there is no advertising request at Step S36 (No at Step S36), or if the process at Step S37 is terminated, the control unit 32 terminates the process.

The following describes the advertising information output process A at Step S35. FIG. 15 is a flowchart illustrating information processing performed in the advertising information output process A.

As illustrated in FIG. 15, at the start of the advertising information output process A, the control unit 32 updates the terminal detection table based on the entry information that is determined to have been acquired at Step S34 (Step S40). The control unit 32 determines whether to output the advertising information to the wireless terminal 5 that has entered the site corresponding to the partner company C (Step S41).

The control unit 32, upon determining to output the advertising information (Yes at Step S41), selects the advertising mode based on the advertisement delivery history table stored in the advertisement DB 43 (Step S42). Next, the control unit 32 determines whether the selected advertising mode is the retargeting mode (Step S43).

If the selected advertising mode is not the retargeting mode (No at Step S43), the control unit 32 extracts, from the partner information DB 41, user information corresponding to the entry site of the wireless terminal 5 (Step S44). The control unit 32 then extracts advertising information according to the extracted user information from the advertisement DB 43 and outputs the extracted advertising information to the wireless terminal 5 that has entered the site corresponding to the partner company C (Step S45).

If it is determined at Step S43 that the selected advertising mode is the retargeting mode (Yes at Step S43), the control unit 32 extracts, from the advertising information table of the advertisement DB 43, advertising information related to the targeted advertising information. The control unit 32 then outputs the extracted advertising information to the wireless terminal 5 that has entered the site corresponding to the partner company C (Step S46).

If it is determined at Step S41 that the advertising information is not output (No at Step S41), if the process of Step S45 is terminated, or if the process of Step S46 is terminated, then the control unit 32 terminates the process.

The following describes the advertising information output process B at Step S37. FIG. 16 is a flowchart illustrating information processing performed in advertising information output process B.

As illustrated in FIG. 16, when the advertising information output process B is started, the control unit 32 selects the advertising mode based on the advertisement delivery history table stored in the advertisement DB 43 (Step S50). Next, the control unit 32 determines whether the selected advertising mode is the retargeting mode (Step S51).

If the selected advertising mode is not the retargeting mode (No at Step S51), the control unit 32 extracts, from the partner information DB 41, user information on the user U having the wireless terminal 5 from which the advertising request originates (Step S52). The control unit 32 then acquires, from the advertisement DB 43, advertising information according to the extracted user information and outputs the advertising information to the wireless terminal 5 from which the advertising request originates (Step S53).

If it is determined at Step S51 that the selected advertising mode is the retargeting mode (Yes at Step S51), the control unit 32 extracts, from the advertising information table of the advertisement DB 43, advertising information related to the targeted advertising information. The control unit 32 then outputs the extracted advertising information to the wireless terminal 5 from which the advertising request originates (Step S54). If the process of Step S53 or the process of Step S54 is terminated, then the control unit 32 terminates the process.

### 4. Other Embodiments

The embodiment described above detects entry in the site corresponding to the partner company C using the wireless apparatus 6. Instead, the advertisement delivery apparatus 4 can detect the entry of the wireless apparatus 6 in the site corresponding to the partner company C based on information from the wireless terminal 5.

If, for example, the wireless terminal 5 has a GPS function, the entry information acquiring unit 52 detects the entry of the wireless terminal 5 in the site corresponding to the partner company C based on latitude and longitude information transmitted from the wireless terminal 5. In this case, position range information that associates information indicating an entry detection range with the store ID is stored in the entry information DB 42 in advance. The entry information acquiring unit 52 extracts, from the position range information, the store ID corresponding to the entry detection range including the latitude and the longitude of the wireless terminal 5 based on the latitude and longitude information transmitted from the wireless terminal 5.

If the entry information including the business ID and the store ID is transmitted from the wireless terminal 5, the control unit 32 of the advertisement delivery apparatus 4 may detect the entry of the wireless terminal 5 in the site corresponding to the partner company C based on the entry information from the wireless terminal 5. In this case, the wireless terminal 5 includes a storage that stores therein information that associates the position information on the “site corresponding to the partner company C” with the business ID and the store ID. The control unit of the wireless terminal 5 compares, based on the information stored in the storage, the position information on the “site corresponding to the partner company C” with the latitude and the longitude of the current position to thereby detect the business ID and the store ID of the entry site. The control unit of the wireless terminal 5 then transmits the entry information including the business ID and the store ID to the advertisement delivery apparatus 4.

If a plurality of pieces of targeted advertising information having a “1” set as the retargeting flag are set on the advertisement delivery history table, the first advertising information output unit 55 and the second advertising information output unit 57 can narrow down candidates for the objects of the retargeted advertising according to, for example, the attributes of the user U having the wireless terminal 5, behavior of the user U in the immediate past, time of day, day of the week, and weather. This enables retargeted advertising to be performed to achieve even greater advertising effects.

If, in the retargeting mode, the wireless terminal 5 enters the partner company C that sells a commodity or service as the object of the targeted advertising, the first advertising information output unit 55 may output the retargeted advertising information related to the targeted advertising information. The first advertising information output unit 55 can determine commodities and services sold by the partner company C based on, for example, the user information on the partner information DB 41.

In addition, the first advertising information output unit 55 and the second advertising information output unit 57, after outputting retargeted advertising information, can also newly set on an advertisement delivery history table by setting the retargeted advertising information as targeted advertising information. This further enhances the advertising effect of the retargeted advertising.

### 5. Hardware Configuration

The information management apparatus 2 according to the embodiment may be achieved by a computer 60 configured, for example, as illustrated in FIG. 17. FIG. 17 is a hardware configuration diagram of an exemplary computer that achieves the functions of the information management apparatus 2. The computer 60 includes a central processing unit (CPU) 61, a random access memory (RAM) 62, a read only memory (ROM) 63, a hard disk drive (HDD) 64, a communication interface (I/F) 65, an input/output interface (I/F) 66, and a media interface (I/F) 67.

The CPU 61 operates based on a computer program stored in the ROM 63 or the HDD 64 to thereby control different elements. The ROM 63 stores therein, for example, a boot program executed by the CPU 61 during the start of the computer 60 and a computer program dependent on the hardware of the computer 60.

The HDD 64 stores therein, for example, a computer program executed by the CPU 61 and data used by the program. The communication I/F 65 corresponds to the communication unit 30. The communication I/F 65 receives data from other devices and sends the data to the CPU 61 over the communication network 7, and transmits data generated by the CPU 61 to other devices over the communication network 7.

The CPU 61 controls output devices such as a display and a printer and input devices such as a keyboard and a mouse via the input/output I/F 66. The CPU 61 acquires data from the input devices via the input/output I/F 66. The CPU 61 transmits generated data to the output devices via the input/output I/F 66.

The media I/F 67 reads a computer program or data stored in a recording medium 68 and provides the CPU 61 with the program or data via the RAM 62. The CPU 61 loads the program on the RAM 62 from the recording medium 68 via the media I/F 67 and executes the loaded program. The recording medium 68 is, for example, an optical recording medium such as a digital versatile disc (DVD) and a phase change rewritable disk (PD), a magneto-optical recording medium such as a magneto-optical disk (MO), a tape medium, a magnetic recording medium, or a semiconductor memory.

The computer 60 functions as the information management apparatus 2 when the CPU 61 of the computer 60 executes the program loaded on the RAM 62 to thereby achieve the function of each of the user information acquiring unit 51, the entry information acquiring unit 52, the advertising determining unit 53, the information extracting unit 54, the first advertising information output unit 55, the advertising request receiving unit 56, and the second advertising information output unit 57. Additionally, the HDD 64 achieves the function of the storage unit 31 and stores therein, for example, the partner company's user information table, the terminal detection table, the advertisement delivery history table, the partner company information table, the correspondence information table, the advertising information table, and the user information table.

The CPU 61 of the computer 60 loads these programs from the recording medium 68. Alternatively, the CPU 61 may acquire these programs from other devices over the communication network 7.

### 6. Effects

The advertisement delivery apparatus 4 of the advertisement delivery system 1 according to the present embodiment includes the partner information DB 41 (an exemplary company information DB), the entry information acquiring unit 52, the information extracting unit 54, the first advertising information output unit 55, and the second advertising information output unit 57. The partner information DB 41 stores therein the user information on the partner company C (an exemplary company). The entry information acquiring unit 52 acquires, as the entry information, information on the site corresponding to the partner company C and information on the wireless terminal 5 that has entered the site corresponding to the partner company C. The information extracting unit 54 extracts, from the partner information DB 41, user information on the partner company C corresponding to the entry site of the wireless terminal 5 based on the entry information. The first advertising information output unit 55 outputs, to the wireless terminal 5, the advertising information (the exemplary first advertising information) according to the user information extracted by the information extracting unit 54. The second advertising information output unit 57 outputs, to the wireless terminal 5, the advertising information (the exemplary second advertising information) corresponding to the user U having the wireless terminal 5 that has accessed the server 3 (an exemplary server). The first advertising information output unit 55 and the second advertising information output unit 57 output, to the wireless terminal 5 to which the targeted advertising information (exemplary one advertising information of the first advertising information and the second advertising information) has been output, advertising information related to the targeted advertising information as the retargeted advertising information (exemplary the other advertising information of the first advertising information and the second advertising information).

This enables the retargeted advertising to be performed between what is called offline user behavior and online user behavior, achieving the targeted advertising with high accuracy. For example, a user U having a wireless terminal 5 that has accessed the server 3 or the like may be provided with advertising information related to the advertising information output when this user U enters a site corresponding to the partner company C. This enables retargeted advertising with high accuracy. Alternatively, the advertisement delivery apparatus 4 may even provide a user U having a wireless terminal 5 that has entered the site corresponding to the partner company C with advertising information related to the advertising information output when this user U accessed the server 3.

The advertisement delivery apparatus 4 includes the advertisement DB 43 (an exemplary output history storage) that stores therein for each user a history of advertising information output made by one advertising information output unit of the first advertising information output unit 55 and the second advertising information output unit 57. The other advertising information output unit of the first advertising information output unit 55 and the second advertising information output unit 57 outputs, based on the output history, retargeted advertising information related to the targeted advertising information output by the one advertising information output unit.

This facilitates selection and output of the retargeted advertising information related to the targeted advertising information.

The first advertising information output unit 55 and the second advertising information output unit 57 terminate the output of the retargeted advertising information, when the advertising effect by the retargeted advertising information satisfies a predetermined condition.

This prevents unlimited performance of the retargeted advertising, so that the effect of the retargeted advertising can be achieved effectively.

The entry information acquiring unit 52 acquires entry information from the wireless apparatus 6 (an exemplary wireless LAN access point) having the site corresponding to the partner company C as the wireless communication area.

With a wireless LAN access point installed in the site corresponding to the partner company C, the foregoing arrangement allows entry of the wireless terminal 5 in the site corresponding to the partner company C to be detected without the need for any other wireless apparatus.

The first advertising information output unit 55 outputs the advertising information to the wireless terminal 5 that has entered the site corresponding to the partner company C when the time period of stay of the wireless terminal 5 within the communication area of the wireless apparatus 6 and/or the radio wave strength of the wireless terminal 5 acquired by the wireless apparatus 6 satisfy a predetermined condition.

This allows a specific object to which the advertising information is to be output to be targeted, as selected out of the wireless terminals 5 that have entered the site corresponding to the partner company C. The foregoing arrangement further excludes the wireless terminal 5 that stays in the communication area of the wireless apparatus 6 only for a short period of time and that is not very much related to the site corresponding to the partner company C.

The advertisement delivery apparatus 4 includes the user information acquiring unit 51 that acquires user information owned by each of a plurality of partner companies C. The partner information DB 41 stores therein the user information on the partner companies C acquired by the user information acquiring unit 51.

This allows the user information on the partner companies C to be provided, so that the advertising information can be targeted at the user U of a specific one of the partner companies C. The purchase of commodities can thereby be promoted effectively and with high accuracy.

### 7. Miscellaneous

Some embodiments of the present application have been described in detail with reference to the accompanying drawings. These embodiments are only illustrative and are not intended to limit the present invention. It is understood that changes and modifications may be made without departing from the spirit and scope the present invention.

The advertisement delivery apparatus 4 may be achieved by a plurality of server computers. The configuration of the advertisement delivery apparatus 4 can also be flexibly changed, including achieving some of its functions by calling an external platform using an application programming interface (API) or network computing, for example.

An embodiment of the present invention can provide an advertisement delivery apparatus, an advertisement delivery method, and an advertisement delivery program enabling targeted advertising with high accuracy.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An advertisement delivery apparatus comprising;
a company information database configured to store therein user information on a company;
an entry information acquiring unit configured to acquire entry information including information on a wireless terminal when the wireless terminal enters a site corresponding to the company;
an information extracting unit configured to extract, from the company information database, the user information on the company corresponding to an entry site of the wireless terminal based on the entry information;
a first advertising information output unit configured to output advertising information according to the user information extracted by the information extracting unit as first advertising information to the wireless terminal; and
a second advertising information output unit configured to output advertising information according to a user having a wireless terminal when the wireless terminal accesses a server as second advertising information to the wireless terminal,
one of the first and second advertising information output units outputting, to the wireless terminal to which the advertising information of the other advertising information output unit is output, advertising information related to the advertising information output from the other advertising information output unit.

2. The advertisement delivery apparatus according to claim 1, further comprising:
an output history storage configured to store therein for each user having the wireless terminal a history of output made by the other advertising information output unit, wherein
the one advertising information output unit outputs, based on the output history, advertising information related to the advertising information output from the other advertising information output unit.

3. The advertisement delivery apparatus according to claim 2, wherein the one advertising information output unit terminates the output of the advertising information related to the advertising information output from the other advertising information output unit when an advertising effect by the advertising information related to the advertising information output from the other advertising information output unit satisfies a predetermined condition.

4. The advertisement delivery apparatus according to claim 1, wherein the entry information acquiring unit acquires the entry information from a wireless LAN access point having the site corresponding to the company as a wireless communication area.

5. The advertisement delivery apparatus according to claim 4, wherein, when a time period of stay of the wireless terminal within the communication area of the wireless LAN access point and/or radio wave strength of the wireless terminal acquired at the wireless LAN access point satisfy a predetermined condition, the first advertising information output unit outputs the first advertising information to the wireless terminal that enters the site corresponding to the company.

6. The advertisement delivery apparatus according to claim 1, further comprising:
a user information acquiring unit configured to acquire user information owned by each of a plurality of companies, wherein
the company information database stores therein user information on the companies acquired by the user information acquiring unit.

7. An advertisement delivery method implemented by a computer, the advertisement delivery method comprising:
(a) acquiring entry information including information on a wireless terminal when the wireless terminal enters a site corresponding to a company;
(b) extracting, from a company information database that stores therein user information on the company, the user information on the company corresponding to an entry site of the wireless terminal based on the entry information;
(c) outputting advertising information according to the user information extracted at the extracting as first advertising information to the wireless terminal; and
(d) outputting advertising information according to a user having a wireless terminal when the wireless terminal accesses a server as second advertising information to the wireless terminal,
one of the (c) outputting and the (d) outputting includes outputting, to the wireless terminal to which advertising information of the other outputting is output, advertising information related to the advertising information output at the other outputting.

8. The advertisement delivery method according to claim 7, wherein
the one outputting includes outputting, based on a history of output made by the other outputting, advertising information related to the advertising information output at the other outputting.

9. The advertisement delivery method according to claim 8, wherein the one outputting includes terminating the output of the advertising information related to the advertising information output at the other outputting when an advertising effect by the advertising information related to the advertising information output at the other outputting satisfies a predetermined condition.

10. The advertisement delivery method according to claim 7, wherein the acquiring includes acquiring the entry information from a wireless LAN access point having the site corresponding to the company as a wireless communication area.

11. The advertisement delivery method according to claim 10, wherein, the (c) outputting includes outputting, when a time period of stay of the wireless terminal within the communication area of the wireless LAN access point and/or radio wave strength of the wireless terminal acquired at the wireless LAN access point satisfy a predetermined condition, the first advertising information to the wireless terminal that enters the site corresponding to the company.

12. The advertisement delivery method according to claim 7, further comprising:
(e) acquiring user information owned by each of a plurality of companies, and
(f) storing user information on the companies acquired at the (e) acquiring in the company information database stores.

13. A non-transitory computer readable storage medium containing program instructions for delivering adverting information, wherein execution of the program instructions by one or more processors of a computer system causes the one or more processors to perform:
(a) acquiring entry information including information on a wireless terminal when the wireless terminal enters a site corresponding to a company;
(b) extracting, from a company information database that stores therein user information on the company, the user information on the company corresponding to an entry site of the wireless terminal based on the entry information;
(c) outputting advertising information according to the user information extracted at the extracting as first advertising information to the wireless terminal; and
(d) outputting advertising information according to a user having a wireless terminal when the wireless terminal accesses a server as second advertising information to the wireless terminal,
one of the (c) outputting and the (d) outputting, to the wireless terminal to which the advertising information of the other outputting is output, advertising information related to the advertising information output at the other outputting.
